(19) United States
(12) Patent Application Publication
(10) Pub. No.: US 2012/0092225 A1
(43) Pub. Date: Apr. 19, 2012

(54) Deformable reflecting membrane for reconfigurable reflector, reconfigurable antenna reflector and antenna including such a membrane

(75) Inventors: Ludovic SCHREIDER, Fonsorbes (FR); Serge DEPEYRE, Blagnac (FR); Victorien BELLOEIL, Bourg Saint Bernard (FR); Philippe LEPELTIER, Castanet (FR); Jean-Philippe TAISANT, Toulouse (FR)

(73) Assignees: CENTRE NATIONAL D'ETUDES SPATIALES, Paris (FR); THALES, Neuilly-sur-Seine (FR)

(21) Appl. No.: 13/035,860

(22) Filed: Feb. 25, 2011

(30) Foreign Application Priority Data
Feb. 26, 2010 (FR) 10 00805

(51) Int. Cl. H01Q 15/14; H01Q 19/10

(52) U.S. Cl. 343/834; 343/915

(57) ABSTRACT

A deformable reflecting membrane includes, in thickness, an alternating superposition of layers of conductive elastomer and at least two reinforcing layers, each reinforcing layer being divided up into individual patches spaced apart from one another and distributed periodically in the plane of the reinforcing layer. The membrane is applicable notably to the space domain.

### CROSS-REFERENCE TO RELATED APPLICATION

This application claims priority to foreign French patent application No. FR 1000805, filed on Feb. 26, 2010, the disclosure of which is incorporated by reference in its entirety.

### FIELD OF THE INVENTION

The present invention relates to a deformable reflecting membrane for reconfigurable reflector, a reconfigurable reflector including such a membrane and an antenna including such a reflector. It applies to any antenna reflector for which the shape of the beam is required to be modified in service and more particularly to the field of space applications such as satellite telecommunications.

### BACKGROUND

A conventional method for obtaining a beam with shaped contour consists in using a multiple lighting feed, according to a suitable illumination law, a single or double eccentric reflector system, even a multiple direct radiation feed. The radiating elements of the feed are excited with signals whose phases and amplitudes are optimized by means of a beam-forming network (BFN) comprising a plurality of waveguides. However, this type of antenna, called array antenna, is very complex and exhibits radiofrequency energy losses and a significant weight that is detrimental to installation on a satellite.

To obtain a radiation pattern that has a predefined contour, it is also known to use a single feed associated with a system of single or double reflectors with shaped surface, that is to say, that have specific geometry defining on the ground a region that has a non-circular contour, for example, a country or a group of countries. The optical path variations between the feed and different points of the reflector make it possible to generate beams that have a phase and amplitude pattern that corresponds to the characteristics of the desired radiation pattern.

Because of the extended life of satellites, it becomes necessary to be able to modify, in orbit, the shape of the beams and therefore the contour of the area on the ground, without changing the reflector in order to compensate for the orbital position variations or to address new service constraints. To reconfigure an array antenna in orbit, it is known to use BFNs that employ a dynamic control of the phase and/or amplitude laws making it possible to modify the illumination law in the case of a multiple feed in front of a system of reflectors or, directly, the radiated pattern in the case of a multiple direct radiation feed. To reconfigure a reflector antenna in orbit, it is also known to employ one or more reflectors whose reflecting surfaces are deformable in order to be able to modify the radiation pattern.

It is notably known from the document FR 2 678 111, to produce a reconfigurable reflector antenna by using a reflecting surface formed by a knitted fabric or a mesh fabric. The drawback with these mesh fabrics is the lack of stiffness, which necessitates combining the mesh fabric with a rigid carrying structure which may, for example, consist of a grid of stiff orthogonal wires, the grid being fixed to its periphery. However, for the reflector of the antenna not to create radiofrequency disturbances in the reception band Rx, such as, notably, third-order intermodulation products, which are the most critical radiofrequency interferences in the Ku band, it is essential for the mesh fabric to be very taut. As it happens, it is very difficult, or even impossible, to control a uniform fabric tension when the surface of the reflector is not planar but deformed to generate the desired ground coverage.

It is also known to use a reflecting surface comprising a membrane that is both flexible like a knitted fabric and dimensionally stable by using carbon fibres bonded by a silicone. However, this type of membrane has a high stiffness which makes it difficult to produce a non-developable deformed surface of any kind (the expression “developable surface” should be understood to mean a surface which can be created from a planar surface, such as a cylinder or a cone for example). Depending on the profile of the surface to be produced, the stiffness of the membrane may in particular cause folds. Furthermore, this membrane creates significant levels of third order intermodulation products that do not conform to the usual Ku band requirements.

Another known type of reflecting surface consists in using a grid of stiff orthogonal wires whose edges are free, the grid being held and constrained to a predetermined shape only by control points. A model has been constructed by using wires consisting of piano wires with a diameter of 0.3 mm and a distance between wires of 10 mm for a reflector diameter of 30 cm. Nine control points were used to deform the surface. However, the radiofrequency reflectivity of this reflecting surface is inadequate in the Ku band and the contacts between each wire of the grid are potential sources of unacceptable intermodulation products.

### SUMMARY OF THE INVENTION

The aim of the invention is to remedy the drawbacks of the known deformable reflecting surfaces and to produce a deformable reflecting membrane with high radiofrequency reflectivity that has a highly elastic area allowing significant deformations in multiple directions within and outside of the plane of the surface of the membrane, exhibiting a deflection stiffness and a low coefficient of thermal expansion that allows for a dimensional stability of the membrane over a temperature range that is compatible with a space application, and a good electrical uniformity or electric contacts insulated from one another so as not to create significant levels of intermodulation products.

For this, the invention relates to a deformable reflecting membrane for reconfigurable reflector, comprising, in thickness, an alternating superposition of layers of conductive elastomer and at least two discontinuous reinforcing layers, each reinforcing layer being divided up into individual patches spaced apart from one another and distributed periodically in the plane of the reinforcing layer.

Advantageously, the individual reinforcing patches are arranged staggered from one layer to another.

Preferably, the number of reinforcing layers is even.

In the case where the number of reinforcing layers is odd, the distribution of the reinforcing patches in the different reinforcing layers has a mirror symmetry relative to the plane of the reinforcing layer located at the centre of the membrane.

Advantageously, the reinforcing layer is made from a material with low coefficient of thermal expansion such as fibres made of iron and nickel alloy, for example Invar, or carbon fibres. The constituents of the reinforcing layer may also be stainless steel or tungsten fibres or any other material that has identical properties.

Advantageously, the conductive elastomer is an elastomer charged with metal particles and has an electrical conductivity of between 2.10⁻³ Ω/cm and 5.10⁻³ Ω/cm.

Advantageously, the conductive elastomer may comprise 30% silicone and 70% metal particles.

The invention also relates to a reconfigurable antenna reflector and an antenna including such a deformable reflecting membrane.

### BRIEF DESCRIPTION OF THE DRAWINGS

Other particular features and advantages of the invention will be clearly apparent hereinafter in the description given as a purely illustrative and non-limiting example, with reference to the appended schematic drawings which represent:

FIG. 1: a cross-sectional diagram of an exemplary deformable reflecting membrane portion, according to the invention;

FIGS. 2a and 2b: two diagrams, respectively in perspective and in transversal cross section, of the staggered arrangement of the patches of four different reinforcing layers in the thickness of the membrane, according to the invention;

FIGS. 3a and 3b: two diagrams of the distribution of the reinforcing patches in the plane of the reinforcement for two different reinforcing layers, according to the invention;

FIG. 4a: a first exemplary Gregorian antenna with double reflector with a deformable reflecting membrane mounted on the main reflector, according to the invention;

FIGS. 4b and 4c: two overall and detail views of a second exemplary Gregorian antenna with double reflector with a deformable reflecting membrane mounted on the subreflector, according to the invention.

### DETAILED DESCRIPTION

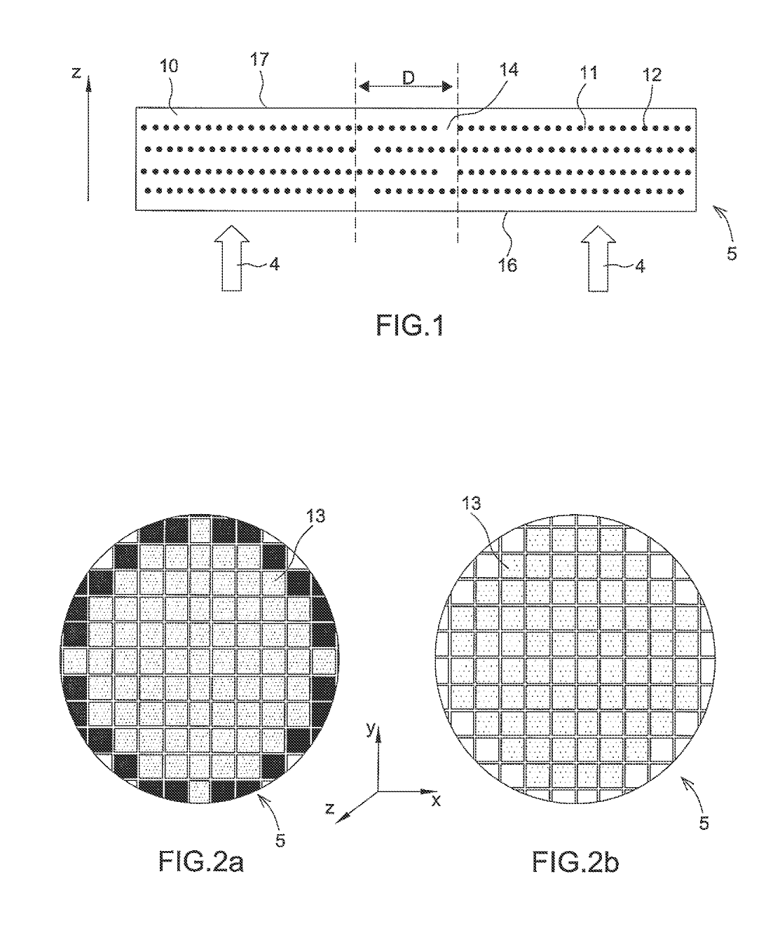

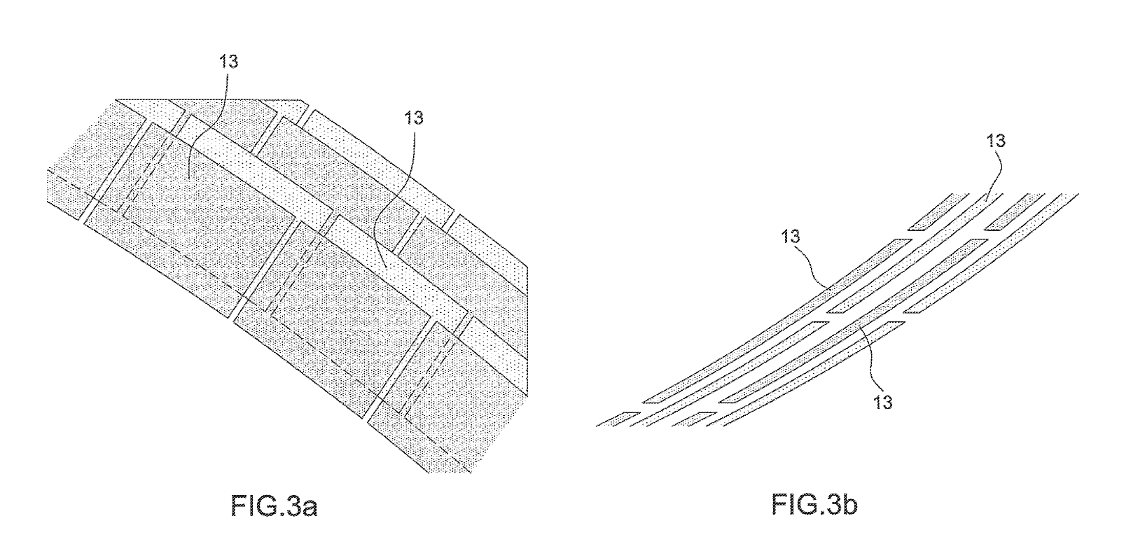

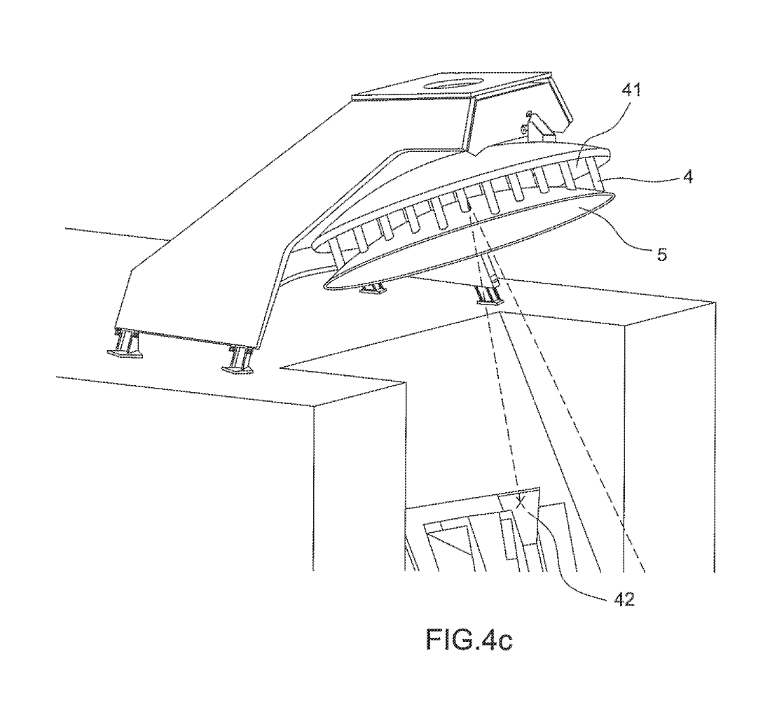

The membrane portion 5 represented in FIG. 1 comprises, in thickness along the axis Z, an alternating superimposition of layers of conductive elastomer 10 and reinforcing layers 11, each reinforcing layer being non-uniform in the plane XY of the reinforcing layer. Each reinforcing layer 11 is discontinuous and consist of individual patches 13 spaced apart from one another and distributed periodically in the plane XY of the reinforcing layer. The patches 13 may, for example, consist of grids of discontinuous wires, the grids of wires forming fabrics comprising stiff wires 12 with a high Young's modulus greater than 100 Gpa and with a very short elastic region, for example of the order of 0.2% elongation (it will be recalled that the percentage elongation of an elastic material corresponds to the ratio between its stretch capacity and its length). The wires 12 are preferably made of a material with low coefficient of thermal expansion, below 10 ppm/° C., such as, for example, carbon fibres or fibres made of iron and nickel alloy such as Invar (registered trademark) or Kovar (registered trademark) and the diameter of the wires 12 is, for example, between 50 and 200 micrometres. The fibres could also be made of another type of material such as stainless steel or tungsten. The number of reinforcing layers 11 including discontinuous patches 13 is greater than or equal to two, the patches 13 staggered from one reinforcing layer to another as represented in FIGS. 2a and 2b, so that the patches 13 of the different reinforcing layers 11 overlap and so that the discontinuities 14 of each reinforcing layer 11 are not placed one above the other. The overlap regions D of the patches 13 make it possible to have a membrane 5 that has a uniform stiffness. Actuators 4 regularly fixed to the bottom face 16 of the membrane 5 make it possible to vary its shape locally and obtain, when the membrane 5 is mounted as an antenna reflector, a radiation pattern that conforms to that which is desired. The membrane 5 may be mounted, for example, as the reflector of an antenna with single reflector or as the main reflector 40 of a Gregorian antenna as represented for example in FIG. 4a or on the subreflector 41 of a Gregorian antenna comprising a main reflector and a subreflector as represented in the overall and detail views of FIGS. 4b and 4c.

The conductive elastomer 10 is an elastomer charged with metal particles. The metal particles are embedded in a binder, for example silicone, forming the base of the elastomer. This type of material has an elastic behaviour and a high deformation capacity of the order of several tens of percent of elongation. The radiofrequency reflectivity of the elastomer depends on its charge rate. For example, to have a satisfactory reflectivity in the Ku band, it is necessary for the electrical conductivity of the membrane to be between 2.10⁻³ Ω/cm and 5.10⁻³ Ω/cm. The percentage of metal particles introduced into the elastomer is therefore determined in order to observe these electrical membrane conductivity values.

In particular, as a nonlimiting example, a silicone elastomer comprising 70% metal charges and 30% elastomer base has a satisfactory reflectivity in the Ku band over a temperature range which depends on the elastomer base used. For example, the conductive elastomer, known by the registered trade mark GT1000, consisting of a 30% base of charged silicone and 70% silvered copper particles has a measured reflectivity equal to −0.18 dB at 14.5 GHz and an elongation capacity greater than 70% over the temperature range between −50° C. and +125° C. The metal particles that charge the elastomer are insulated from one another by the elastomer, such as, for example, silicone, which makes it possible to have a behaviour that is satisfactory with regard to the third, fifth and seventh order intermodulation products in the Ku band which are of the order of −160 to −180 dBc for two 100 watt carriers. It is also possible to use other types of conductive elastomer, such as, for example, the conductive elastomer known by the name CV2 2646 which comprises a base consisting of a silicone copolymer charged with metal particles, which is stable in a temperature range of between −115° C. and +250° C. and which has an elongation capacity of 75%.

The drawbacks with charged elastomers are a high coefficient of thermal expansion CTE, of the order of 150 ppm/° C. and a lack of deflection stiffness. It is possible to reduce the coefficient of thermal expansion and increase the stiffness of the charged elastomers by augmenting the charge rate, but this is to the detriment of its deformation capabilities.

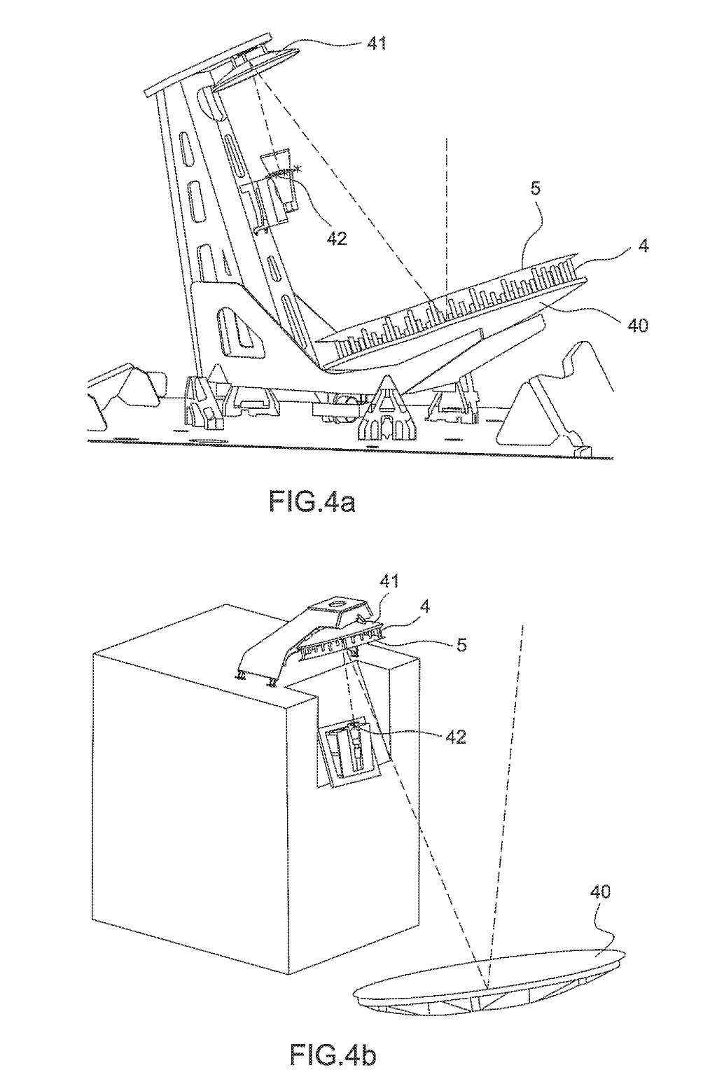

The incorporation of discontinuous reinforcing layers 11 in the charged elastomer 10 makes it possible to provide the charged elastomer with a mechanical reinforcement and to dimensionally stabilize the membrane 5. To allow large deformations of the membrane 5 in directions outside of its plane, each reinforcing layer is divided up in the form of patches which are distributed periodically in the plane XY of the reinforcing layer as represented in FIGS. 3a and 3b. To minimize the stiffness discontinuities between the regions that make up a patch 13 and the regions 14 located between two patches, the patches 13 are arranged staggered from one layer to another. The number of reinforcing layers depends on the dimensions and on the period of the patches 13. Preferably, to have a uniform behaviour of the membrane 5 in the plane XY, the number of reinforcing layers in its thickness along the axis Z is even. Alternatively, when the number of reinforcing layers is odd, the distribution of the patches 13 in the different reinforcing layers preferably has a mirror symmetry relative to the plane of the reinforcing layer located at the centre of the membrane. In this way, the position of the reinforcing patches 13 is symmetrical in the thickness of the membrane 5 which then exhibits an identical behaviour on its two bottom 16 and top 17 faces.

Producing the membrane 5 entails a first step during which a preform is fabricated that consists of a fine membrane of conductive elastomer approximately 0.5 mm thick. The preform is placed in a mould that has the shape of the desired mean reference surface for the reflector. In a second step, the reinforcing patches, for example comprising stiff woven wires, the wires being able to be preferably made of a material with low CTE such as carbon fibres or Invar fibres, or of a material such as stainless steel or tungsten, are laid periodically over the entire surface of the preform while leaving a distance, for example, of a few millimetres between patches. The patches may, for example, be squares of fabric with a side measurement of 6 to 7 cm, or any other shape and any other dimension. In a third step, a new conductive elastomer preform is placed on the first layer of patches, then a second layer of patches is laid, the patches of the second layer being arranged staggered relative to the patches of the first layer of patches, and so on until the desired number of layers is obtained, the final layer being a layer of conductive elastomer.

In general, three or four reinforcing layers in the thickness of the membrane are sufficient.

The different layers placed in the mould are then joined together by polymerization of the elastomer, either at ambient temperature or in an oven or a furnace at a melting temperature of the silicone used, for example between 110° and 200° C., for one to two hours, depending on the type of silicone chosen. The membrane is then removed from the mould and can be used as the deformable reflecting surface of a reflector.

The shape of the membrane can then be modified in service in a known manner by using actuators 4 fixed on the bottom surface 16 of the membrane 5 at chosen positions. The actuators 4 may, for example, be of the piezoelectric type or comprise rotary drive electric motors coupled with a nut system associated with a worm screw, the nut being fixed to the membrane. The actuators 4 push or pull on the membrane 5 to deform it and give it the desired shape. It is also possible for the links between the actuators and the membrane to be ball-jointed or flexible to minimize the radial forces induced in the actuators. Some actuators are better than others at withstanding the radial forces and, depending on the actuators used, it may be necessary to use ball joints. In the case of the use of ball-jointed links, the membrane may move in the plane, the coefficient of thermal expansion of the wires is less critical and the wires may be made of materials other than Invar and carbon. Notably, in this case, the wires may be made of materials such as stainless steel or tungsten.

FIGS. 4a, 4b, 4c show examples of Gregorian antennas comprising a main reflector 40 and a subreflector 41. A feed 42 is placed in front of the subreflector 41. The membrane 5 may be used as the reflecting surface of the main reflector 40 as in FIG. 4a or as the reflecting surface of the subreflector 41 as in FIGS. 4b and 4c. The membrane may also be applied to an antenna with a single reflector.

Although the invention has been described in relation to particular embodiments, it is obvious that it is in no way limited and that it includes all the technical equivalents of the means described and their combinations, provided that they fall within the context of the invention.

1. A deformable reflecting membrane for a reconfigurable reflector, comprising, in thickness along an axis Z, an alternating superposition of layers of conductive elastomer and at least two discontinuous reinforcing layers, each reinforcing layer being divided up into individual patches spaced apart from one another and distributed periodically in a plane XY of the reinforcing layer.

2. A deformable reflecting membrane according to claim 1, wherein the individual patches are arranged staggered from one layer to another.

3. A deformable reflecting membrane according to claim 2, wherein the number of reinforcing layers is even.

4. A deformable reflecting membrane according to claim 1, wherein the number of reinforcing layers is odd and wherein the distribution of the patches in the different reinforcing layers has a mirror symmetry relative to the plane of a reinforcing layer located at a centre of the membrane.

5. A deformable reflecting membrane according to claim 1, wherein the patches of each reinforcing layer comprise a grid of wires, the wires being fibres made of iron and nickel alloy.

6. A deformable reflecting membrane according to claim 5, wherein the iron and nickel alloy is INVAR alloy.

7. A deformable reflecting membrane according to claim 5, wherein the iron and nickel alloy is a material with a low coefficient of thermal expansion.

8. A deformable reflecting membrane according to claim 5, wherein the iron and nickel alloy is a material with a coefficient of thermal expansion below 10 ppm/° C.

9. A deformable reflecting membrane according to claim 1, wherein the patches of each reinforcing layer comprise of a grid of wires, the wires being carbon fibres.

10. A deformable reflecting membrane according to claim 1, wherein the patches of each reinforcing layer comprise of a grid of wires, the wires being stainless steel or tungsten fibres.

11. A deformable reflecting membrane according to claim 1, wherein the conductive elastomer is an elastomer charged with metal particles and has an electrical conductivity of between 2.10⁻³ Ω/cm and 5.10⁻³ Ω/cm.

12. A deformable reflecting membrane according to claim 11, wherein the conductive elastomer comprises 30% silicone and 70% metal particles.

13. A reconfigurable antenna reflector, comprising a deformable reflecting membrane according to claim 1.

14. An antenna, comprising a reflector according to claim 13.

15. A reconfigurable antenna reflector, comprising a deformable reflecting membrane according to claim 2.

16. An antenna, comprising a reflector according to claim 15.

17. A reconfigurable antenna reflector, comprising a deformable reflecting membrane according to claim 5.

18. An antenna, comprising a reflector according to claim 17.

19. A reconfigurable antenna reflector, comprising a deformable reflecting membrane according to claim 1, wherein the patches of each reinforcing layer comprise of a grid of wires, the wires being carbon fibres or stainless steel or tungsten fibres.

20. An antenna, comprising a reflector according to claim 19.
